(19) United States
(12) Patent Application Publication
(10) Pub. No.: US 2004/0233477 A1
(43) Pub. Date: Nov. 25, 2004

(54) Digital halftoning

(75) Inventors: Mikel J. Stanich, Longmont, CO (US); Gerhard R. Thompson, Wappingers Falls, NY (US); Chai Wah Wu, Poughquag, NY (US)

Correspondence Address: SAWYER LAW GROUP LLP, PO BOX 51418, PALO ALTO, CA, 94303, US

(73) Assignee: International Business Machines Corporation, Armonk, NY

(21) Appl. No.: 10/442,854

(22) Filed: May 21, 2003

(51) Int. Cl. H04N 1/405

(52) U.S. Cl. 358/3.14; 358/3.13

(57) ABSTRACT

A method is disclosed for halftoning images either via a direct method or a threshold array construction. The method includes comparing a pattern to an image and calculating a first potential in order to determine a first set of pixels to move; calculating a second potential in order to determine a second set of pixels in which to move the first set of pixels; and then moving pixels in the first set of pixels having high first potentials to pixel locations in the second set of pixels having low second potentials. The method may further include an inner program loop that decreases the number of pixels to move in the first and second sets and iteratively repeats the above steps; and an outer program loop that resets the number of pixels moved in the first and second sets and iteratively repeating the process to further optimize the pattern.

### FIELD OF THE INVENTION

The present invention generally relates to digital halftoning, and more particularly, to a method and system for generating halftoned images.

### BACKGROUND OF THE INVENTION

Most printers today can print in only a limited number of colors. Digital halftoning is a technique for converting a contone image to a new image which can be printed or displayed using a limited number of colors. The new image is such that it appears to consist of many colors when viewed at a distance. For example, a picture of black and white dots can appear to display gray levels when viewed from some distance. Halftoning algorithms can be classified into three classes. The first class of methods, called point algorithms, determines a halftone output pixel based on the value of a current pixel. This class of algorithms includes the widely used dither algorithms. The second class of methods, called neighborhood algorithms, determines a halftone output pixels based on values of a current pixel, and other pixels and function values in a neighborhood of the current pixel. This class of methods includes error diffusion. (see R. Ulichney, “Digital halftoning”, MIT Press, 1987). The third class of methods, called global methods, determines the halftone output pixels based on all the input pixels. This class of methods include direct binary search (DBS) methods (see J. Allebach, “DBS: retrospective and future directions”, Proc. SPIE, vol. 4300, pp. 358-376, 2001).

Conventional methods for generating halftoned images include the void-and-cluster method, and the Direct Binary Search (DBS) method. The void-and-cluster method generates blue noise by moving black pixels in clusters to white pixels in voids. A method referred to as BIPPSMA (binary pattern power spectrum manipulation algorithm) is similar, but moves several pixels at a time in an inner loop. However, the BIPPSMA method does not recalculate the error in determining the voids as the void-and-cluster method does. In DBS methods, the error function is determined by a mean squared error similar to BIPPSMA, but the update of the error after moving a pixel is determined by a sequence of additions and table look-up operations.

These conventional approaches are restricted in which pixels are moved and where the pixels are moved to. For instance, in void and cluster, the pixel to be moved is a single pixel which corresponds to the maximum of the potential function, and the location where the pixel is moved corresponds to the minimum of a second potential function. This can cause the algorithm to stop at a local minimum, which is far from optimal. And in BIPPSMA, the pixels to be moved and the location where they are moved to correspond to maxima and minima of the same potential function. In other words, in BIPPSMA, the second potential function is the same as the first potential function, which causes the error metric to increase in some iterations. In direct binary search screen design, the second potential function is more complicated and requires several table lookups and additions per pixel and the potential function kernel must necessarily be an autocorrelation function.

Accordingly, what is needed is an improved method for performing digital halftoning. The present invention addresses such a need.

### SUMMARY OF THE INVENTION

The present invention provides a method and system for halftoning images either via a direct method or a threshold array construction. The method includes comparing a pattern to an image and calculating a first potential to determine a first set of pixels to move; calculating a second potential to determine a second set of pixels in which to move the first set of pixels; and then moving pixels in the first set of pixels having high first potentials to pixel locations in the second set of pixels having low second potentials. The method may include an inner program loop that decreases the number of pixels to move in the first and second sets and iteratively repeats the above steps; and an outer program loop that resets the number of pixels moved in the first and second sets and iteratively repeats the process to further optimize the pattern.

According to the method and system disclosed herein, the present invention provides more flexibility in choosing the pixels to be moved, the locations they are moved to and the stopping criteria of the inner and outer iterations of the algorithm.

### BRIEF DESCRIPTION OF THE DRAWINGS

FIG. 1 is a block diagram illustrating a digital halftoning system.

FIG. 2 is a flow chart illustrating the digital halftoning process in accordance with a preferred embodiment of the present invention.

FIG. 3 is a diagram of pseudo code for the digital halftoning process that halftones an image by iteratively moving restricted pixels to restricted locations.

### DESCRIPTION OF THE PREFERRED EMBODIMENTS

The present invention relates to method for performing digital halftoning. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown but is to be accorded the widest scope consistent with the principles and features described herein.

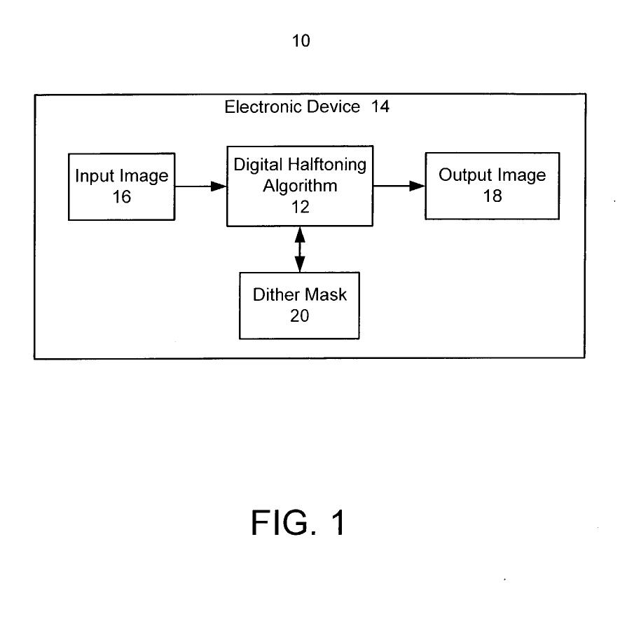

FIG. 1 is a block diagram illustrating a digital halftoning system. The system 10 includes a digital halftoning algorithm 12 that is executed in an electronic device 14 for converting a digital, continuous-tone input image 16 into a binary output image 18 for printing or display. Examples for the electronic device 14 may include a computer, printer, scanner, copier, facsimile, and camera, for instance. The digital halftoning algorithm 12 may be stored on any computer-readable medium, such as internal non-volatile memory, disk, or networked storage device. Alternatively, the digital halftoning algorithm 12 may be implemented as hardware, rather than software.

The digital halftoning algorithm 12 may be used to halftone the input image 16 directly, or to create a dither mask 20 for halftoning the image 16. The result of the halftoning process is output image 18 having solid spots of colorants to create the illusion of different grays or colors. As is well known in the art, the dither mask 20 may be used to create the output image 18 by comparing a particular pixel l(x,y) in the input image 16 with a corresponding point D(i,j) in the dither mask 20 and producing a spot (e.g., binary 1) at a particular point O(x,y) in the output image 18 if the intensity of pixel l(x,y) is greater than D(i,j).

According to the present invention, the digital halftoning algorithm 12 generates halftones by iteratively moving sets of pixels, where the pixels in the set are restricted by evaluating the first potential function. Sets of pixel locations where these pixels are moved to are also restricted by evaluating the second potential function. In a preferred embodiment, the second potential function is determined from the first potential function by removing the potentials due to the pixels which are moved.

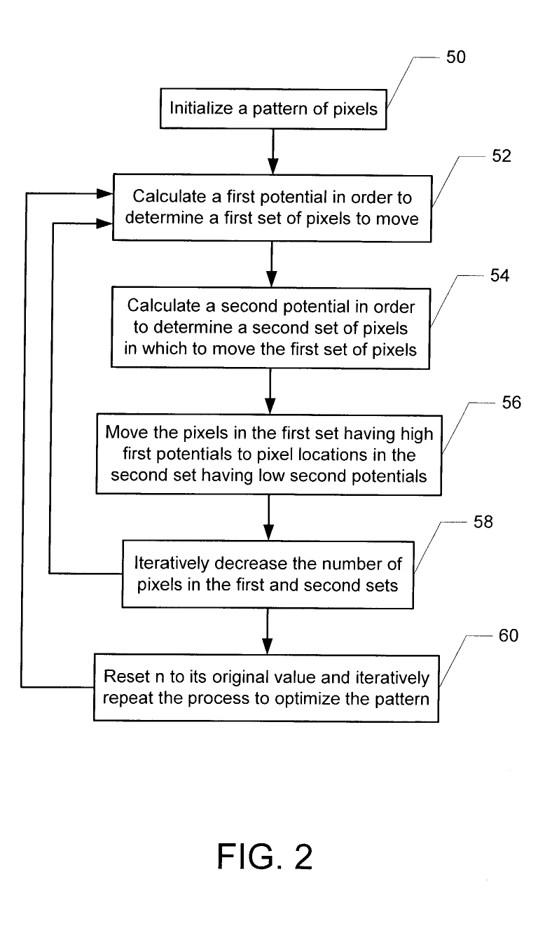

FIG. 2 is a flow chart illustrating the digital halftoning process in accordance with a preferred embodiment of the present invention. The process begins in step 50 by generating an initial pattern of pixels. In step 52, a first potential is calculated in order to determine a first set of pixels to move. In step 54, a second potential is calculated in order to determine a second set of pixels in which to move the first set of pixels. In step 56, the pixels in the first set, which is determined as pixels having high first potentials and satisfying a first set of constraints are moved to pixel locations in the second set, which is determined as having low second potentials and satisfying a second set of constraints. In step 58, steps 52-56 are iteratively repeated with a decreasing number of pixels in the first and second sets. By iteratively reducing the number of pixels, n, in the first and second sets, a visually pleasing pattern is provided, but the pattern may not be optimal. Therefore, optionally, in step 60, n is reset to its original value and the process (steps 52-58) is iteratively repeated to optimize the pattern. The inner loop and the outer loops are exited when the corresponding stopping criteria are met.

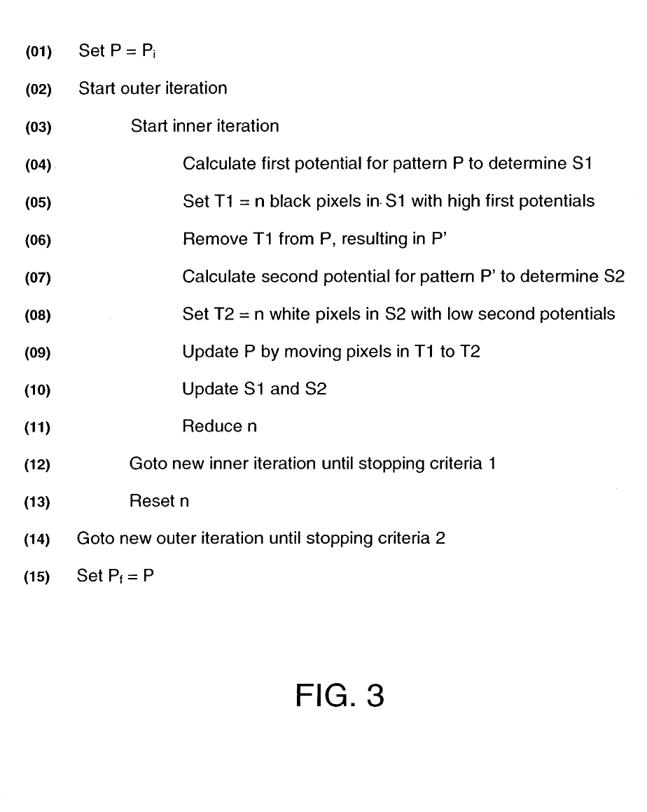

FIG. 3 is a diagram of pseudo code for the digital halftoning process that halftones an image by iteratively moving restricted pixels to restricted locations. Given an image I and an initial halftone pattern Pᵢ, the algorithm 12 produces the output image 18 as a final pattern P_{f}. The final pattern P_{f}, which is a halftone approximation of l, is created by iteratively moving pixels in a set S1 to pixel locations in a set S2 using inner and outer program loops. In one preferred embodiment, the image 16 comprises a matrix of real numbers between 0 and 1, and the halftone pattern comprises a matrix of 0's and 1's.

The process begins in line 1 by initializing a variable P to the input pattern Pᵢ. A pattern P is a matrix of “0s” and “1s”, where 0 corresponds to white pixels and 1 corresponds to black pixels, although a person skilled in the art can interchange “black” with “white”. When this halftoning algorithm is used to create dither masks, each pattern Pᵢ corresponds to a gray level g and each pattern may be used to render a particular level of gray. When halftoning an image, the initial pattern Pᵢ is chosen in the preferred embodiment to have a number of black pixels such that it has the same average gray as the image. In lines 2 and 3, outer and inner iteration loops are started.

In line 4, the first potential for pattern P is calculated to determine which pixels in the set S1 to move. In a preferred embodiment, the first potential is calculated by measuring the difference between the halftone pattern P and the image I by L₁ (P−I), where L₁ is a linear operator. The resulting array of differences is also called the filter error or the filter response. ∥L₁(P−I)∥ is the norm of the filter error, e.g., the maximum value of |L₁(P−I)| over all pixel locations (the L-infinity norm), and is used as a measure of how different the two images look to a human observer at some distance.

Next, in line 5, a number n of black pixels in S1 with high first filter errors, i.e. high potentials from L₁(P−I) are designated as a set T1. In line 6, a new pattern, P′, is created by removing the set of pixels T1 from the halftone pattern P, making these black pixels white in P′.

In line 7, a potential for P′ is calculated to determine which pixels in S2 to move the pixels in T1 to. In a preferred embodiment, this second potential is calculated by L₂(P′−I). The linear operators L₁ and L₂ are chosen in the preferred embodiment as linear low pass filters describing the Human Visual System (HVS). In a preferred embodiment, L₁ is equal to L₂. Some examples of such filters can be found in R, Nasanen, “Visibility of halftone dot textures,” IEEE Trans. Syst. Man, and Cyb., vol. 14, pp. 920-924, 1984 and in L. Sullivan, L. Ray, and R. Miller, “Design of minimal visual modulation halftone patterns,” IEEE Trans. Syst. Man, and Cyb., vol. 21, pp. 33-38, 1991.

In line 8, n white pixels in S2 with low second filter errors, i.e., low potentials, from L₂(P′−I) are designated as a set T2. In general, the set T2 does not have to be chosen at once, but one or more of the n pixels may be chosen and made black, then P′ updated, the second filter errors from L₂(P′−I) recalculated, and the cycle repeated until n white pixels in S2 have been made black. Similarly, the set T1 can be chosen one (or more) pixel at a time.

As an example, T1 can be chosen as the n black pixels with the k-th, (k+1)-th, . . . (k+n−1)-th largest first filter errors in S1 for some integer k. If n=2 and k=4, then T1 can be chosen as the 2 black pixels with the fourth and the fifth largest first filter errors in S1. When these pixels are made white, a new pattern is created, P′, and second filter errors are calculated based on this pattern. Similarly, the set T2 is based on low second filter errors in S2, which may be chosen in one or more iterations.

In line 9, the pattern P is updated by moving the pixels in set T1 to T2. In line 10, S1 and S2 are updated to satisfy the first and second set of constraints, respectively. In line 11, n is reduced and the inner iteration is repeated in line 12 until a first stopping criteria is reached. The first stopping criteria could be when the number n is less than one. In line 13, n is reset, and in line 14, the outer iteration is repeated until a second stopping criteria is reached. The second stopping criteria could be when a maximum number of iterations has been reached and/or when the norm of the first or second filter error has not decreased significantly. In line 15, a final pattern Pf is set equal to P.

As stated above, the digital halftoning algorithm 12 can be used to generate the dither mask 20 or to halftone the input image 16. Each process is explained below.

Generating Dither Masks

The digital halftoning algorithm 12 may generate a dither mask as follows. Creating a dither mask corresponds to creating a series of patterns, each corresponding to a level of gray, with these patterns satisfying a stacking constraint, i.e. the black pixels locations in the pattern for a lighter gray is a subset of the black pixels locations in the pattern for a darker gray. We will use algorithm 12 to generate these patterns, while using the restricted sets S1 and S2 to make these patterns satisfy the stacking constraint. First, a halftone pattern for gray level g1 is created by an initial pattern generation phase which assigns g1*SIZE pixels to black, setting S1 to be this set of black pixels, setting S2 as all pixels and running the digital halftoning algorithm 12, where the image I is the uniform gray at gray level g1 and SIZE is the size of the mask. Next, the patterns corresponding to levels above and below g1 are generated one at a time as follows. Suppose the gray level g has been generated. To generate a gray level g′>g, start with the pattern for gray level g. Add (g′−g)*SIZE additional black pixels to the pattern and let S1 be this set of additional black pixels and S2 be all the pixels except the pixels in the pattern for gray level g and apply the digital halftoning algorithm 12 with the image I being the uniform gray image at gray level g′. When updating S1 and S2 after moving the black pixels in each iteration (line 10 in FIG. 3), S1 is updated to be the set of additional black pixels (which are moved in every iteration) and S2 remains the same. To generate patterns for g′<g, reverse the roles of black and white pixels. The method of interpolating between good patterns in dither masks as described in U.S. Pat. No. 5,917,951 and U.S. Pat. No. 6,025,930 can easily be adapted to use the current invention by anyone with ordinary skill in the art. In particular, these patents describe how S1 and S2 are determined and updated to interpolate between good patterns.

There are two ways to implement the initial pattern generation phase and the generation of additional pixels. Either the black pixels are randomly assigned or the following procedure is used. In this procedure, the black pixels are put down one at a time. At each step, the filter response is recalculated and a black pixel is put down on the location in S1 with the lowest response. The filter response can be updated using the updating method described in the next section.

Since I is constant in this application, the locations of maximum and minimum of L(P−I) is the same as the locations of maximum and minimum of L(P), and thus, the potentials are calculated as L(P) instead of L(P−I) in order to reduce the amount of computations.

Halftoning Images

The digital halftoning algorithm 12 can be used to halftone an image 1. In this case, S1 and S2 are all the pixels in the image. In the application in the previous section where the dither mask 20 is constructed, the algorithm 12 can take a long time to finish as the dither mask is constructed once and the same dither mask is used to halftone different images. In this application where the algorithm 12 is used to halftone images 16, the algorithm 12 must be very efficient to be practical. In the preferred embodiment for this application, a single black pixel is swapped with a single white pixel (i.e., n is always 1 in FIG. 3.) Instead of calculating the filter response each time a pixel is removed and inserted, only the change in the filter response is computed and added to the old filter response to construct the new filter response. This technique is used in Direct Binary Search (DBS) algorithms. Assuming the support of the filter in the space domain to be small, the change in the filter response can be computed efficiently.

More specifically, let d(x,y) be the filter response of the linear filter on a single black pixel at position (0,0), i.e. d(x,y) is the impulse response centered at (0,0), then the change in the filter response due to adding a pixel at location (u,v) is equal to adding d(x−u mod N, y−v mod M) to the filter response where the array is of size N by M. A small support of the filter means that the number of nonzero elements of d(x,y) is small. Similarly, the filter response of swapping a black pixel at (u₁,v₁) with a white pixel at (u₂,v₂) is determined by adding d(x−u₂ mod N, y−v₂ mod M)−d(x−u₁ mod N, y−v₁ mod M) to the filter response.

Assume one wants to determine where to move a specific black pixel at (u₁,v₁) to. For a preferred embodiment where L₁=L₂, finding the lowest (or lower) potential in L₂(P′−I) where P′ is the pattern obtained by removing the black pixel at (u₁,v₁) from P can be done by subtracting d(x−u₁ mod N, y−v₁ mod M) from the first potential and finding the minimum (or near minimum). Note that this requires only one addition operation (and 2 table lookups) per location (x;y) examined, as contrasted with DBS where 3 addition operations (and 4 table lookups) are required to evaluate one location (x,y). After it is determined to move a black pixel at (u₁,v₁) to a white pixel at (u₂,v₂), the first potential for the next iteration can be obtained by adding d(x−u₂ mod N, y−v₂ mod M) to the second potential.

Techniques used by DBS implementations to limit the pixels which are moved and the number of locations searched to determine the minimum, corresponding to updating the sets S1 and S2 (line 10 in FIG. 3), can readily be used in this invention by anyone skilled in the art.

The present invention is different from conventional halftoning techniques in the following aspects. In the void-and-cluster method, the pixel from the highest potential of the first potential function is moved to the lowest potential of the second potential function. This can result in patterns which are not pleasant as pointed out in D. J. Lieberman and J. P. Allebach, “On the relation between DBS and Void and Cluster”, IS&T's NIP14: 1998 International Conference on Digital Printing Technologies, pp. 290-293. In the proposed invention, by contrast, locations in S2 in which to move the pixels from the first potential function is determined by some of the lower, but not necessarily the lowest, potentials of the second potential function. Furthermore, the void-and-cluster method fails to perform an inner iteration that iteratively reduces the number of pixels to be moved.

In BIPPSMA, only one potential function is used, compared with the use of two potential functions in the present invention. In DBS, the determination of T2 (i.e. where to move the black pixels to) requires several additions and table look-ups, whereas in the proposed invention this requires fewer additions and table look-up operations. When the filter response in the preferred embodiment is restricted to be an autocorrelation function (or the convolution of an impulse response of a filter with itself), the error to be minimized is the same as the mean square error in DBS. In other words, the potential in DBS must necessarily be an autocorrelation function due to the use of the mean squared error, whereas in the proposed invention, this requirement is absent.

Another difference with DBS is that the computation in the present invention is split into two parts, calculating the first potential and calculating the second potential. The second potential is derived from the first potential via a small amount of computation to determine the change between the first potential and the second potential. The second potential is necessary to determine where to move a pixel to. The first potential in the next iteration is computed from the second potential by a small amount of computation. In DBS, there is no concept of two potentials. This corresponds to calculating the first potential in each iteration from the first potential in the last iteration, forgoing the benefit in the current invention of using some of the computation already done to calculate the second potential (which is also needed in DBS, although not explicitly stated as a second potential) in calculating the first potential of the next iteration. Therefore in general, it is expected that this algorithm of the present invention performs faster than DBS for the same application.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is:

1 A method for performing digital halftoning, the method comprising the steps of:
(a) generating an initial pattern of pixels;
(b) comparing the pattern to an image and calculating a first potential and determining a first set of pixels to move;
(c) calculating a second potential and determining a second set of pixels in which to move the first set of pixels; and
(d) moving pixels in the first set of pixels having high first potentials to pixel locations in the second set of pixels having low second potentials.

2 The method of claim 1 further including the step of:
(e) iteratively repeating steps (b)-(d) with a decreasing number of pixels to move in the first and second sets.

3 The method of claim 2 further including the step of:
(f) resetting the number of pixels to move in the first and second sets to an original value and iteratively repeating steps (b)-(e) to optimize the pattern.

4 The method of claim 1 wherein step (b) further includes the step of: calculating the first potential by measuring a difference between the pattern P and the image I by L₁ (P−I), where L₁ is a linear operator.

5 The method of claim 4 wherein step (b) further includes the step of: designating a number, n, of black pixels in the first set with high first filter errors from L₁(P−I) as a set T1.

6 The method of claim 1 wherein the first set is determined by finding the pixels which satisfy a first set of constraints.

7 The method of claim 5 wherein step (b) further includes the step of: creating a new pattern, P′, by removing the set of pixels T1 from the pattern P, making the black pixels white in P′.

8 The method of claim 7 wherein step (c) further includes the step of: calculating the second potential by calculating a potential for P′ by L₂(P′−I).

9 The method of claim 8 wherein step (c) further includes the step of: designating n white pixels in the second set with low second filter errors from L₂(P′−I) as a set T2.

10 The method of claim 1 wherein the second is determined by finding the pixels which satisfy a second set of constraints.

11 The method of claim 9 wherein step (d) further includes the step of: updating the pattern by moving the pixels in set T1 to set T2.

12 The method of claim 11 wherein step (d) further includes the step of: updating first and second sets to satisfy a first and second set of constraints.

13 The method of claim 2 wherein step (e) further includes the step of: stopping the iteration of reducing the number of pixels when a number of pixels is less than one.

14 The method of claim 3 wherein step (d) further includes the step of: stopping the iteration of optimizing the pattern when either a maximum number of iterations has been reached or when the norm of a first filter error has not decreased significantly.

15 The method of claim 1 further including the step of calculating the first and second potentials with linear operators L₁ and L₂, where L₁=L₂.

16 The method of claim 1 wherein step (a) further includes the step of: providing the pattern as a matrix of “0s” and “1s”, corresponding to white and black pixels.

17 The method of claim 16 wherein step (a) further includes the step of: providing a plurality of patterns, Pᵢ, where each pattern Pᵢ corresponds to a gray level.

18 The method of claim 17 wherein a plurality of images are provided, each image is an image of a constant gray level.

19 The method of claim 18 wherein the method is used to create a dither mask.

20 The method of claim 19 wherein the dither mask is used to halftone an image by comparing values in the mask with the pixel values of the image at each pixel, outputting a solid color pixel if the value of the mask is higher than the pixel value of the image, and outputting no color otherwise.

21 A computer readable medium containing program instructions for performing digital halftoning, the program instructions for:
(a) generating an initial pattern of pixels;
(b) comparing the pattern to an image calculating a first potential and determining a first set of pixels to move;
(c) calculating a second potential and determining a second set of pixels in which to move the first set of pixels; and
(d) moving pixels in the first set of pixels having high first potentials to pixel locations in the second set of pixels having low second potentials.

22 The computer readable medium of claim 21 further including the instruction of:
(e) iteratively repeating instructions (b)-(d) with a decreasing number of pixels to move in the first and second sets.

23 The computer readable medium of claim 22 further including the instruction of:
(f) resetting the number of pixels to move in the first and second sets to an original value and iteratively repeating instructions (b)-(e) to optimize the pattern.

24 The computer readable medium of claim 21 wherein instruction (b) further includes the instruction of: calculating the first potential by measuring a difference between the pattern P and the image I by L₁ (P−I), where L is a linear operator.

25 The computer readable medium of claim 24 wherein instruction (b) further includes the instruction of: designating a number, n, of black pixels in the first set with high first filter errors from L₁(P−I) as a set T1.

26 The method of claim 21 wherein the first set is determined by finding the pixels which satisfy a first set of constraints.

27 The computer readable medium of claim 25 wherein instruction (b) further includes the instruction of: creating a new pattern, P′, by removing the set of pixels T1 from the pattern P, making the black pixels white in P′.

28 The computer readable medium of claim 27 wherein instruction (c) further includes the instruction of: calculating the second potential by calculating a potential for P′ by L₂(P′−I).

29 The computer readable medium of claim 28 wherein instruction (c) further includes the instruction of: designating n white pixels in the second set with low second filter errors from L₂(P′−I) as a set T2.

30 The method of claim 21 wherein the second is determined by finding the pixels which satisfy a second set of constraints.

31 The computer readable medium of claim 31 wherein instruction (c) further includes the instruction of: updating the pattern by moving the pixels in set T1 to set T2.

32 The method of claim 31 wherein step (d) further includes the step of: updating first and second sets to satisfy a first and second set of constraints.

33 The computer readable medium of claim 22 wherein instruction (e) further includes the instruction of: stopping the iteration of reducing the number of pixels when a number of pixels is less than one.

34 The computer readable medium of claim 23 wherein instruction (d) further includes the instruction of: stopping the iteration of optimizing the pattern when either a maximum number of iterations has been reached or when the norm of a first filter error has not decreased significantly.

35 The computer readable medium of claim 21 further including the instruction of calculating the first and second potentials with linear operators L₁ and L₂, where L₁=L₂.

36 The computer readable medium of claim 21 wherein instruction (a) further includes the instruction of: providing the pattern as a matrix of “0s” and “1s”, corresponding to white and black pixels.

37 The computer readable medium of claim 36 wherein instruction (a) further includes the instruction of: providing a plurality of patterns, Pᵢ, where each pattern Pᵢ corresponds to a gray level.
